(19) United States
(12) Patent Application Publication
(10) Pub. No.: US 2009/0180398 A1
(43) Pub. Date: Jul. 16, 2009

(54) METHOD AND APPARATUS FOR FACILITATING INTERACTION BETWEEN THE SERVICES PROVIDED BY RESPECTIVE NETWORKED DEVICES

(75) Inventor: Stephane Lejeune, San Diego, CA (US)

Correspondence Address: FITCH EVEN TABIN & FLANNERY, 120 SOUTH LASALLE STREET, SUITE 1600, CHICAGO, IL, 60603-3406, US

(73) Assignees: SONY CORPORATION, A JAPANESE CORPORATION, Tokyo (JP); SONY ELECTRONICS INC., A DELAWARE CORPORATION, Park Ridge, NJ (US)

(21) Appl. No.: 12/355,578

(22) Filed: Jan. 16, 2009

Related U.S. Application Data
(60) Provisional application No. 61/011,442, filed on Jan. 16, 2008.
(60) Provisional application No. 61/011,598, filed on Jan. 18, 2008.

(51) Int. Cl. H04L 12/28

(52) U.S. Cl. 370/254

(57) ABSTRACT

A method to facilitate interaction between the services provided by respective networked devices. The method includes receiving service capabilities associated with a source device which has joined a first network, and receiving a service application at a presentation device. The service application is associated with at least one service identified by the service capabilities associated with the source device. The method further includes presenting a service associated with the source device on the presentation device utilizing the service application.

### CROSS-REFERENCE TO RELATED APPLICATIONS

This application claims the benefit of U.S. Provisional Application No. 61/011,442, filed Jan. 16, 2008, which is incorporated in its entirety herein by reference. This application further claims the benefit of U.S. Provisional Application No. 61/011,598, filed Jan. 18, 2008, which is incorporated in its entirety herein by reference.

### BACKGROUND OF THE INVENTION

1. Field of the Invention

The present invention relates generally to home networks, and more specifically to a method to facilitate interaction between the services provided by respective networked devices.

2. Discussion of the Related Art

Recent improvements in home electronic technologies have resulted in electronic devices with significantly enhanced capabilities. Such improved electronic devices can include networking, processing and storage capabilities. These new capabilities make possible the interconnection of many devices to form networks. One advantage of these networked devices is that they can share information and resources. As a result, applications on the networked devices can control and coordinate several devices simultaneously. These improved electronic devices are becoming especially prevalent in the consumer electronics (CE) arena. Typical CE devices include home audio/video (AV) devices (e.g., televisions, audio equipment, VCR's, CD (compact disk) players, DVD (digital video disk) players, BD (BluRay Disk) players), mobile devices (e.g., mobile phone, mp3 players, PDA (Personal digital assistant)) or more sophisticated devices like set-top boxes (e.g., intelligent receiver/decoder IRD), game platforms (e.g., Sony Playstation 3) and personal computers (PCs). These devices are coupled together using a network backbone using various techniques (e.g., a standard IEEE 1394 serial communications bus, Ethernet (TCP/IP), Bluetooth, 802.11, as well as others).

The networked devices communicate using a number of different communication protocols. Typical protocols are defined by standards such as HAVi (Home Audio/Visual Initiative), AV/C (the AV/C Digital Interface Command Set defines a protocol for monitoring and controlling CE devices), IEA 851 (EIA Standard, VHN Home Network Specification, IEA/CEA-851), OSGI (Open Service Gateway Initiative), Control A1, XML (Extended Markup Language), or UPnP (Universal Plug and Play). Work is ongoing in this environment to improve the interaction between networked devices to enhance the capabilities of these devices.

### SUMMARY OF THE INVENTION

In one embodiment, the invention can be characterized as a method to facilitate interaction between the services provided by respective networked devices. The method includes receiving service capabilities associated with a source device which has joined a first network, and receiving a service application at a presentation device. The service application is associated with at least one service identified by the service capabilities associated with the source device. The method further includes presenting a service associated with the source device on the presentation device utilizing the service application.

In another embodiment, the invention can be characterized as an apparatus that includes a receiver configured to receive service capabilities associated with a source device which has joined a first network, and receive a service application, the service application being associated with at least one service identified by the service capabilities associated with the source device. The apparatus further includes a display configured to present a service associated with the source device utilizing the service application.

In a further embodiment, the invention may be characterized as a method to facilitate interaction between networked devices that includes detecting presence of a source device of a first network, obtaining service capabilities associated with the source device, and obtaining a service application from the source device, the service application being associated with at least one service identified by the service capabilities associated with the source device. The method further includes providing the service application to a presentation device operable within the first network, the service application being configured to permit the presentation device to present a service associated with the source device utilizing the service application.

In yet another embodiment, the invention may be characterized as an apparatus that includes a receiver configured to detect presence of a source device, obtain service capabilities associated with the source device, and obtain a service application from the device, the service application being associated with at least one service identified by the service capabilities associated with the source device. The apparatus further includes a transmitter configured to provide the service application to a presentation device operable within the first network, the service application being configured to permit the presentation device to present a service associated with the source device utilizing the service application.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a diagram depicting a network environment in accordance with an embodiment of the present invention.

FIG. 2 is a signal flowchart depicting a method in accordance with an embodiment of the present invention to facilitate interaction between networked devices.

FIG. 3 is a block diagram depicting generalized software and hardware architecture for exemplary presentation and source devices in accordance with an embodiment of the present invention.

FIG. 4 is another block diagram depicting generalized software and hardware architecture for exemplary presentation and source devices in accordance with an embodiment of the present invention.

FIG. 5 is yet another block diagram depicting generalized software and hardware architecture for exemplary presentation and source devices in accordance with an embodiment of the present invention.

FIG. 6 is a block diagram of a source device in accordance with an embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims. By way of initial overview, various embodiments relate to methods to facilitate interaction between devices by extending a home network protocol to include signaling and location information of executable applications. In one embodiment, the home network protocol may be an UPnP and the executable application may be java byte code.

A further embodiment includes a method to facilitate interaction between networked devices. The method includes a first device using home network discovery technology to receive service capabilities from a second device. Further the received service capabilities reference directly or indirectly at least one service application associated with a second device, and is used by the first device to identify and locate a downloadable service application that can be executed on the first device. Further the first device may download (or the application may also still be stored locally from a previous download) and execute the appropriate service application. In addition, the first device may configure the application environment with the location of the second device as discovered through the home network discovery process. Further the application's environment may be configured with the required permission to communicate with the second device and subsequently expose the services provided by this second device to the first device. With this brief overview, the following is now presented.

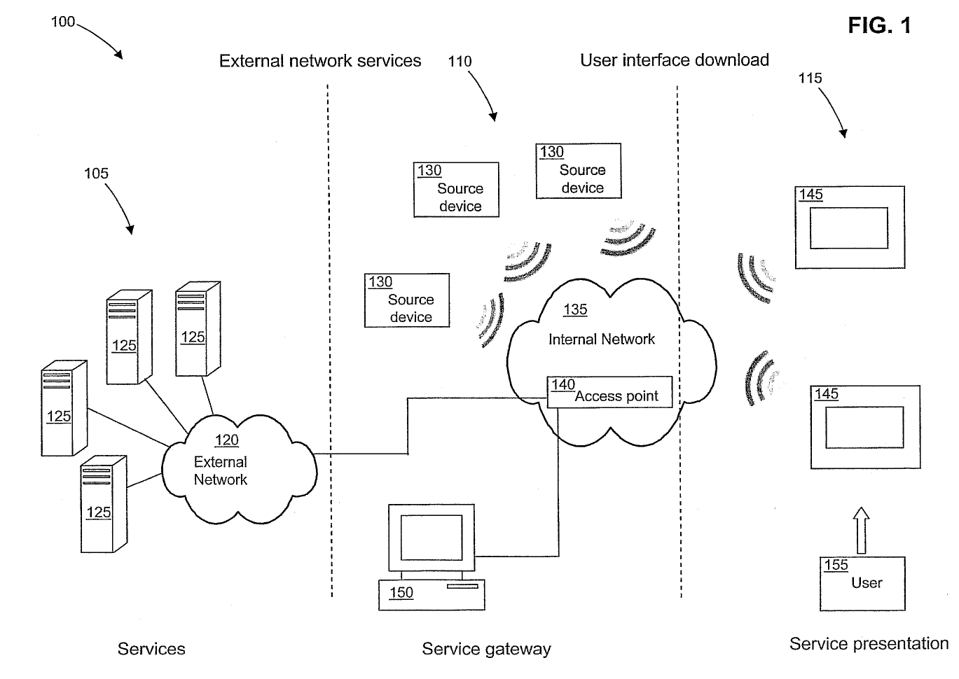

FIG. 1 is a diagram depicting network environment 100 in accordance with an embodiment of the present invention. Network environment 100 is shown having three generalized regions, and in particular, services 105, service gateway 110, and service presentation 115.

Services 105 include external network 120, which is shown interconnecting a plurality of servers 125 with various components of service gateway 110. External network 120 may be implemented using a conventional network topology such as a 3G, WiMAX, wide area network (WAN), metropolitan area network (MAN), virtual private network (VPN), integrated services digital network (ISDN), asynchronous transfer mode (ATM) network, or the Internet, among others.

Data communication between and among various components of the services and service gateway depicted in FIG. 1 may be implemented using conventional packet switched network communication protocols. Examples of such networking protocols include hypertext transport protocol (HTTP), file transport protocol (FTP), transmission control protocol/internetworking protocol (TCP/IP), Ethernet, fiber distributed data interface (FDDI), token bus or token ring networks, serial line IP (SLIP) protocols, and the like. It will be appreciated that the foregoing examples of networking technologies are illustrative only, and that the present disclosure is not intended to be limited with respect to the specific networking protocols or communication standards employed by any of the components illustrated and described herein. FIG. 1 shows several individual servers 125 coupled to external network 120, but the described embodiments are operable with any number of such servers.

Each of the servers 125 may be configured to provide any of a variety of different types of services to other devices present in other regions or portions of network environment 100. In general, such services or applications provide content such as broadcast TV, Internet protocol television (IPTV), web radio, packaged media, telephony services, interactive applications, combinations thereof, and the like.

Service gateway 110 is typically configured with one or more source devices 130 connected to external network 120 using, for example, internal network 135 and associated access point 140. Internal network 135 may be implemented using known wireless or wired network architectures including TCP/IP, Ethernet, IEEE 1394, IEEE 802.11 family of protocols, infrared (e.g., IrDA), and the like. A typical arrangement is to implement the internal network using a peer-to-peer network. The universal plug and play (UPnP) architecture is one example of a network architecture which may be used to implement portions of internal network 135.

A typical source device 130 will provide, facilitate, or otherwise enable a service to be presented on presentation device 145. The source devices implemented may be of the same type or they may be different types of devices. Examples of common source devices include game consoles, wireless printers, routers, computers (e.g., computer 150) digital televisions, television set-top boxes, DVD players, web radio players, networked storage devices, cameras, digital media adapters, mobile phones, mobile terminals, audio speakers, A/V receivers, multi-room audio, and the like.

Access point 140 typically provides two generalized functions. A first function includes supporting communications between various devices communicating via internal network 135. An example includes communications between and among the various devices of service gateway 110 and the devices of service presentation 115. A second function of access point 140 is to facilitate communication between devices of services 105 and service gateway 110 using, for example, external network 120. In some embodiments, such as in an UPnP network, the access point facilitates device discovery, device description, control, event notification, presentation, and other UPnP related functions. Access point 140 is shown as a discrete component, but some or all of the functionality of access point 140 may be integrated with source device 130.

One embodiment implements source device 130 as a digital TV set-top gateway. In such embodiment, external network 120 may further include communication infrastructure to support such devices. In that regard, the external network may be further configured to support various digital TV communication standards and protocols including advanced television systems committee (ATSC) standards, digital video broadcasting for satellite television (DVB-S), data over cable service interface specification (DOCSIS) and the like.

Another embodiment implements source device 130 as a mobile phone or mobile terminal. In such embodiments external network 120 may further include communication infrastructure to support such devices. In that regard, the external network may be further configured to support various wireless communication standards and protocols including the global system for mobile communications (GSM), code division multiple access (CDMA), time division multiple access (TDMA), wideband CDMA (W-CDMA), and the like.

It is common in the mobile phone and mobile terminal embodiments to communicate with servers 125 using a dedicated built in access point. This is because these mobile devices utilize communication protocols established by their associated wireless carriers, and thus, do not require functionality associated with an Internet access point. Note that in such embodiments, access point 140 is still typically used to support communication between source device 130 (e.g., mobile phone) and presentation device 145.

Service presentation 115 typically includes one or more presentation devices 145 coupled to an associated one or more source devices 130 using, for example, internal network 135 and access point 140. In an embodiment, the service that is presented on presentation device 145 is associated with a particular source device 130. User 155 is shown interacting with presentation device 145.

Presentation device 145 generally refers to a device which may be used for presenting a service. This service presentation may take the form of, for example, audio, video, pictures, graphics, interactive applications (e.g., JAVA-based user interface), and combinations thereof. In accordance with various embodiments, presentation device 145 may be implemented using a globally executable multimedia home platform (GEM). Typical GEM technologies that may be implemented include OpenCable application program (OCAP), advanced common application platform (ACAP), Japanese association of radio industries and businesses (ARIB) B23, Blu-ray disc Java (BD-J), and the like.

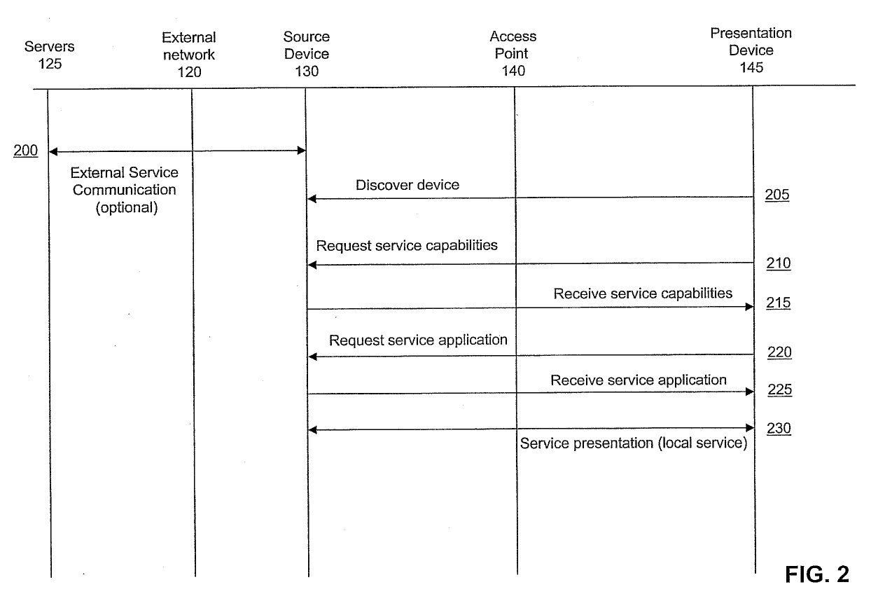

Operation of the arrangement of FIG. 1 in accordance with various embodiments of the present invention will now be described in conjunction with the flowchart of FIG. 2. In particular, FIG. 2 is a signal flowchart depicting a method to facilitate interaction between services provided by networked devices.

Optional operation 200 refers to external communication between source device 130 and the externally located servers 125. In general, this communication includes the obtaining of any desired applications (e.g., a telephone service such as Skype) by the source device.

Various embodiments utilize operation 205 for a device discovery process, which may include detecting the presence of source device 130 relative to presentation device 145, access point 140 of a first network (e.g., internal network 135), or both. A variety of different techniques may be used for detecting the presence of the source device. For instance, in embodiments using UPnP technology, one operation that may be implemented relates to IP addressing. In this instance, each device being added to the network is identified by an identification, such as an IP address. In a managed network, a dynamic host configuration protocol (DHCP) client will typically assign the IP address. On the other hand, in an unmanaged network, each source device will assign this IP addresses (e.g., intelligently choosing an IP address from a set of IP addresses).

Some embodiments also include operation 210, which relates to requesting the service capabilities associated with a discovered source device 130.

Responsive to this request, source device 130 provides the requested information and presentation device 145 consequently obtains the service capabilities associated with source device 130. Referring still to the UPnP technology example, such service capabilities may be obtained as part of a UPnP discovery process. A typical UPnP discovery process allows the source device to advertise its services to other devices (e.g., other source devices 130 and presentation devices 145) that are located on the internal network. The service capabilities may take the form of a device description (e.g., model name, list of embedded devices or services, URLs for control, eventing, presentation, and the like).

In general, the service capabilities communicated to presentation device 145 may be accomplished through direct or indirect reference in the description file which is communicated to the presentation device. One example includes source device 130 providing a direct path of a locally stored application. This technique may be accomplished by placing ajar file of a class path directly in the <presentationURL> field. Another example includes listing locally stored applications. An example of this technique is to extend the UPnP description file to include an application list description that reflects locally stored and exportable GEM applications. As one example, the application list description can conform to the syntax defined in Annex AR (XML encoding for AIT) of the multimedia home platform (MHP) 1.2 specifications. Yet another example is to provide the presentation device of a location of the application list. For instance, this technique may extend the UPnP description file to include a URL that points to a remote or local xml file that describes the application list of remotely available GEM applications. Again the xml file can conform to the syntax as defined in Annex AR (XML encoding for AIT) of the MHP 1.2 specifications. A combination of both can also be used causing the same application to be signaled more than once. In this case, the presentation device could use the different applications list descriptions to intelligently choose to use the application version that best fits. In one embodiment, it could choose the application signaled with the highest version number allowing for transparent software upgrade.

Regardless of the technique utilized, at some point the service capabilities of source device 130 are communicated to presentation device 145, which subsequently receives these service capabilities. The presentation device will then have knowledge of the existence or presence of source device 130, and the service description and the presence and locations of downloadable service applications designed to run on a Java VM based terminal. Examples of Java VM based terminals include, for example, personal based profile (PBP) based terminals such as a GEM based terminal. Examples of such GEM based terminals include MHP, OCAP, ACAP, ARIB, BD-J and Ginga-J. Identification of the application compliance to a specific terminal may be indicated directly of indirectly by the device description file. Another method includes downloading a bootstrap application that is compatible with multiple terminals, probing which terminal it is executing on, and consequently downloading the most appropriate application version for that terminal.

Operation 220 includes a request for a service application referenced by the service capabilities, resulting in operation 225 that obtains a service application from source device 130. In an embodiment, the service application is associated with at least one service identified by the service capabilities of the source device. This operation further includes providing the service application to presentation device 145, which subsequently receives the service application. In general, the service application is configured to permit the presentation device to present a service associated with the source device utilizing the obtained service application. This configuration can be implemented by providing the IP address of the source device to the service application's execution environment. The IP address of the source device could be passed to the application through a variety of options including through the application's parameters, through the application's context, or through a well defined variable or file. The application's permission domain may be configured to include privileges allowing it to open a communication path to the source device. This can be achieved by adding a socket permission based on the source device's IP address obtained during the UPnP discovery process, for example, to the application's permission domain.

The service application may be configured to permit presentation device 145 to operate using a variety of different techniques. According to a first scenario, the service application may be configured to permit presentation device 145 to provide various functions including providing the service model driver, providing a user interface for the service, and providing control of the service, among others. If desired, all of these components may be downloaded to the presentation device as a single application.

According to a second scenario, the service application may be configured to permit the presentation device to gain access to the source device's service based upon the execution of the service application. In this embodiment, the presentation device 145 does not rely upon the service application to include functions such as presenting a user interface for the service and permitting control of the service. Instead, the presenting and control aspects are performed based upon applications native to the presentation device.

According to a third scenario, presentation device 145 receives two service applications. A first application includes components (e.g., view and control drivers) configured to permit the presentation device 145 to provide a user interface for the service. A second application includes components (e.g., a service model driver) configured to permit the presentation device to provide interaction between the user and the service model driver.

In this third scenario, an additional feature provides a user-selectable option for presenting of the service. This option generally permits the user to choose or otherwise alternate between either of the just-described first scenario or a second scenario. For example, according to a first option, presentation device 145 may provide the service (based upon the components in the second application), provide a user interface for the service (based upon the components in the first application), and provide control of the service (based upon the components in the first application).

According to a second option, presentation device 145 may provide the services based upon the second application, while utilizing view and control components residing on the presentation device 145 to provide functions such as presenting a user interface for the service and permitting control for the service. If desired, the user may be permitted to repeatedly switch between these options.

Presenting of the service at presentation device 145 may be realized using any of a variety of different techniques. For instance, operation 230 includes presenting the service at presentation device 145 using data provided from any of a variety of different sources. For instance, such data may be provided by one or more source devices 130, computer 150, and combinations thereof. Consequently, operation 230 depicts providing a local service at presentation device 145 to the extent that data relating to the presented service has been obtained from source device 130. In these localized implementations, it is not necessary to access external network 120 or servers 125. A localized configuration is often implemented when source device 130 does not require communication with a remote component (e.g., server 125) to provide the desired service. Typical source devices utilized in this arrangement are video cameras, picture cameras, A/V storage devices, and the like.

According to other embodiments, data for presenting the service may be provided by one or more servers 125 (via external network 120). These embodiments therefore permit user 155, for example, to interact with a remote service (server 125) via a second network, such as external network 120. In a typical example, the presenting operations utilize JAVA to provide the desired service.

The forgoing describes several techniques for facilitating interaction between source device 130 and presentation device 145. It is understood that multiple source devices and multiple presentation devices may be accommodated by repeating the operations depicted in FIG. 2 for each of these devices.

One embodiment includes presenting one or more services from a plurality of source devices. In this example, operation 215 includes receiving service capabilities associated with a plurality of source devices. Operation 225 likewise includes receiving a service application from each of the plurality of source devices 130 at presentation device 145. Typically, each of the service applications is associated with at least one service identified by the service capabilities associated with one of the plurality of source devices. According to operation 230, presentation device 145 may therefore present a plurality of services that are individually associated with one of the plurality of source devices utilizing the service application that was obtained from each of the plurality of source devices. In some situations, this presenting operation may include simultaneously presenting each of the plurality of these services meshed together.

One alternative embodiment relates to presenting multiple services from a single source device 130. In this embodiment, operation 215 includes receiving a plurality of service applications from source device 130. Each of the service applications in this example is associated with at least one service identified by the service capabilities associated with source device 130. According to operation 230, presentation device 145 presents a plurality of services associated with source device 130 utilizing the plurality of service applications. If desired, this presenting operation may include simultaneously presenting each of the plurality of services.

Still further features in accordance with alternative embodiments are as follows. With regard to operation 225, one possible technique includes automatically receiving the service application at presentation device 145. In some cases, presentation device 145 may be configured in such a manner to permit user interaction with the service via the presentation device.

Another feature allows for the service on presentation device to present options which differ from options possible using source device 130. One example of this is that the source device may not have a display (e.g., a DVD player), but the presentation device does have a display (TV monitor). Accordingly, services presented on the presentation device may utilize this display, thus representing a service that is not possible on the source device.

To facilitate familiarity of the service across multiple platforms, the service presented on presentation device 145 may include a user interface which is the same, or essentially the same, as a user interface for the service presented on source device 130.

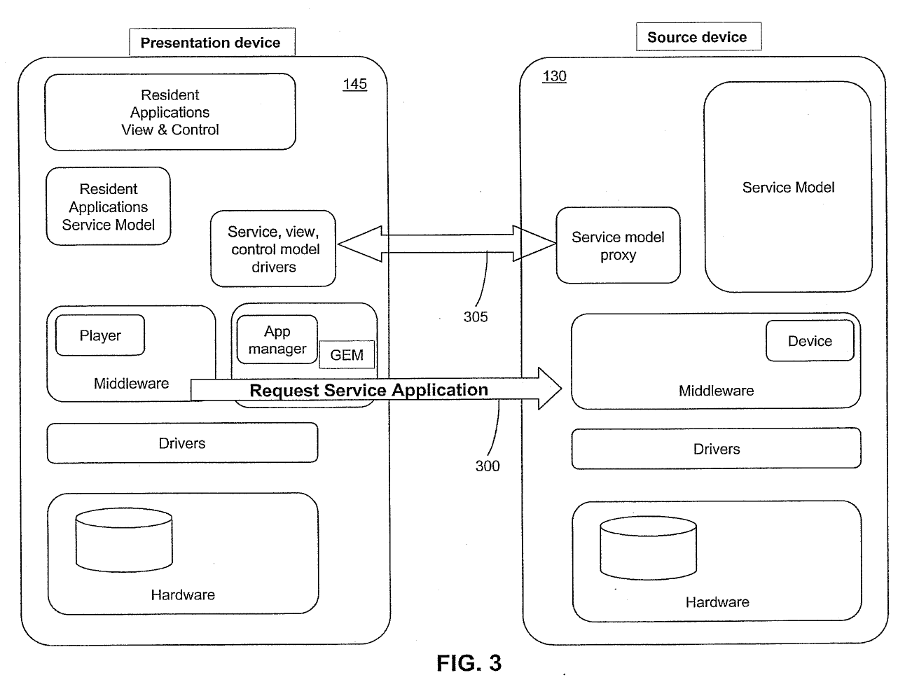

FIG. 3 is a block diagram depicting generalized software and hardware architecture for exemplary presentation and source devices. In particular, software modules associated with presentation device 145 include resident applications relating to the user interface, such as the view and control components. Another application relates to the service model, which relates to the instructions necessary for the presentation device to present the service. The middleware layer is shown having a player (e.g., a UPnP player) and an application manager. The example of FIG. 3 utilizes a GEM terminal application manager. Presentation device 145 also includes drivers and a hardware module to support operation of the device. Source device 130 is similarly configured with service model, device middleware, drivers, and hardware.

Arrow 300 depicts presentation device 145 requesting (e.g., automatically) a service application from source device 130. Recall that the service application is associated with at least one service identified by the service capabilities of the source device. In general, the service application is configured to permit the presentation device to present a service associated with the source device utilizing the obtained service application. The service application may be obtained using the techniques described in operation 225 (FIG. 2). In FIG. 3, this feature is shown by arrow 305.

FIG. 3 depicts the previously described first scenario in which the service application may be configured to permit presentation device 145 to provide various functions including providing the service driver, providing a user interface for the service, and providing control of the service, among other features. If desired, all of these components may be downloaded to the presentation device as a single application. An example of this is shown by arrow 305, such that service, view, and control model drivers are obtained from source device 130 as part of the service application. During service presentation, presentation device 145 communicates with source device 130 using the service model proxy of source device 130.

Benefits of this arrangement for manufactures of source device 130 include the ability to define preferred presentation parameters, tight integration between the service and presentation, and relatively fast-to-market time since integration is not required. Manufactures of presentation device 145 further experience the benefit of not having to tend to integration matters. As for users, the common presentation of the same service over multiple platforms (e.g., source device 130 and presentation device 145) is a generally welcomed feature.

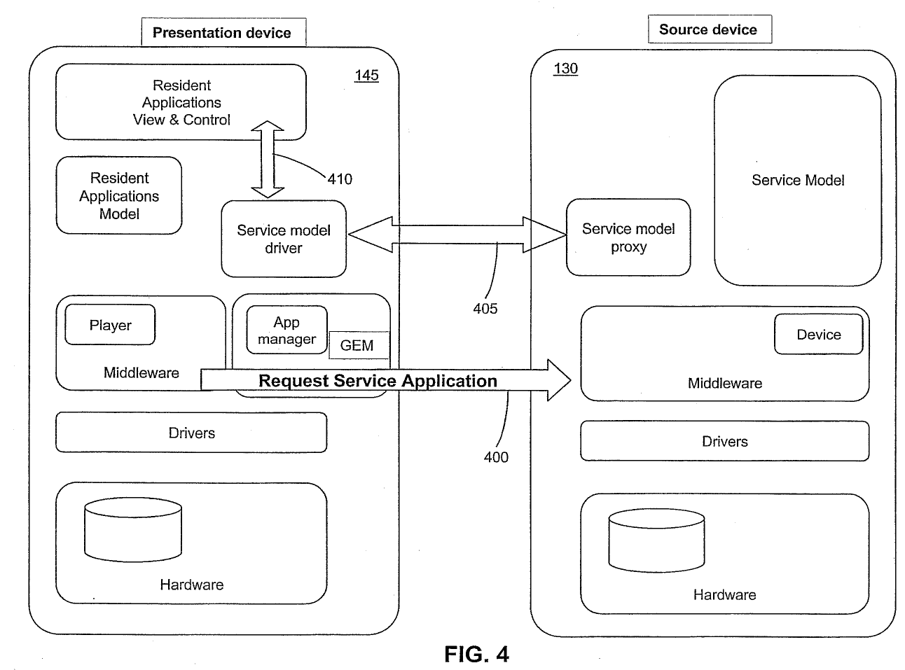

FIG. 4 is another block diagram depicting generalized software and hardware architecture for exemplary presentation and source devices. The software and hardware modules associated with presentation device 145 and source device 130 are similar in many respects to that depicted in FIG. 3. The primary distinctions between these arrangements relate to the content of the service application obtained from source device 130, and consequently, its effect on the resident applications relating to the user interface of presentation device 145.

Arrow 400 depicts presentation device 145 requesting a service application having a service model driver. This service model driver is typically configured to permit presentation device 145 to provide the desired service. An example of this is shown by arrow 405, such that a service model driver is obtained from source device 130 as part of the service application. During service presentation, presentation device 145 communicates with source device 130 using the service model proxy of source device 130.

In contrast to FIG. 3, the embodiment of FIG. 4 relates to presentation device 145 as not relying upon the service application (provided by source device 130) to provide functions such as presenting a user interface for the service and permitting control of such a service. Instead, the presenting and control aspects are performed based upon resident applications located on the presentation device. An example of this feature is shown by arrow 410, such that the view and control components are implemented using applications residing at the presentation device.

In some embodiments, the service model driver includes a defined application programming interface (API). This feature permits a degree of abstraction such that the resident application model interacts with the service model drivers, instead of the resident application view and control components.

Benefits of the arrangement of FIG. 4 for manufactures of source device 130 include the minimizing efforts to the extent that the user interface components are the responsibility of presentation device 145. Advantages for the presentation device include improved integration with other services presented on the device, and retaining control over rendering functionality. Users often appreciate this arrangement since different services will typically include a common presentation.

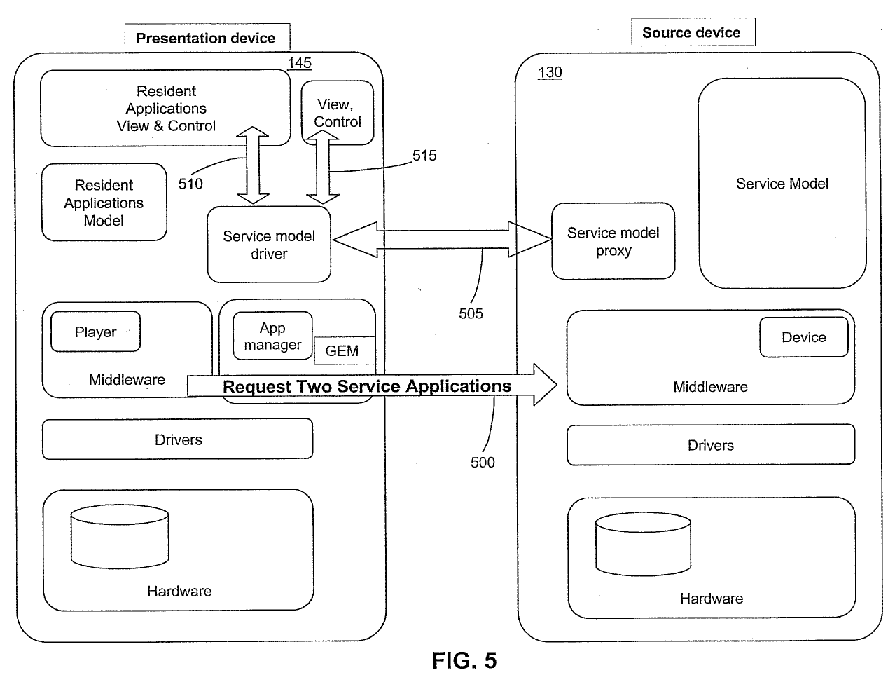

FIG. 5 is yet another block diagram depicting generalized software and hardware architecture for exemplary presentation and source devices. The software and hardware modules associated with presentation device 145 and source device 130 are similar in many respects to that depicted in both FIGS. 3 and 4. The primary distinctions between these arrangements relate to the content of the service application obtained from source device 130, and consequently, its effect on the resident applications relating to the user interface of presentation device 145.

As discussed above, presentation device 145 may include a feature which provides a user-selectable option for presenting of the service. This option generally permits the user or other entity to effectively choose or switch between either the arrangement depicted in FIG. 3 or the arrangement of FIG. 4.

For instance, arrow 500 depicts presentation device 145 requesting two service applications from source device 130. According to this embodiment, a first application includes components (e.g., view and control drivers) configured to permit presentation device 145 to provide a user interface for the service and provide control of the service. A second application includes components (e.g., a service model driver) configured to permit the presentation device to provide the service based upon the service application.

The user-selection operation of the embodiment of FIG. 5 may proceed as follows. In a first option or mode of operation, operation may be achieved in accordance with arrows 505 and 515, such that the presentation device operates using the service model drivers from the second application, and the view and control drivers obtained from the first application.

In a second option or mode of operation, operation may be achieved according to arrows 505 and 510, such that presentation device 145 provides the service based upon the service model driver of the second application, while utilizing the view and control components residing on the presentation device to provide functions such as presenting a user interface for the service and permitting control for the service. If desired, the user may be permitted to repeatedly switch between these options.

The embodiments depicted herein illustrate a home network architecture for peer-to-peer service connectivity of various types of devices (e.g., intelligent appliances, wireless devices, and PCs of all form factors, and the like). This architecture is often characterized as a distributed, open networking architecture to enable seamless service presentation in addition to control and data transfer among networked devices.

Various design features that may be realized in accordance with embodiments of the present invention include flexible connectivity to ad-hoc or unmanaged networks, flexible client/server service framework unrestrained by service profile definitions, flexible presentation framework and management while promoting integration with the local and uniform presentation functions resident in a rendering or presentation device.

Further features include support for zero-configuration, “invisible” networking, and automatic discovery for a breadth of device categories from a wide range of vendors. This means that a source device can dynamically join internal network 135, obtain an identification, convey its capabilities to other devices or access points, and learn about the presence and capabilities of other source or presentation devices. Still further features include automatic service application download for a breadth of services from a wide range of vendors. This means that an arbitrary or proprietary service protocol can dynamically be supported by dynamically installing the appropriate driver from the source device.

Further benefits for source device manufactures include the ability to expand to environments beyond the PC environment, enable or extend presentation to TVs, enhanced integration (e.g., TV user interface, existing TV resident services, UPnP services also exported to the TV), presentation improvement, extend usage of the service, no requirement to standardize the service, and the like.

Consider embodiments in which presentation device 145 includes a TV (e.g., a digital interactive TV) or TV monitor. Such a feature enables source devices, such as those with limited or nonexistent graphical capabilities, to exploit the graphical capabilities of the TV, and the resident applications of the TV as well.

Consider embodiments in which presentation device 145 includes a TV (e.g., a digital interactive TV) or TV monitor. Such a feature also enables source devices, such as those with handwriting recognition, to export their alternative user input capabilities to the TV, and to the resident applications of the TV as well.

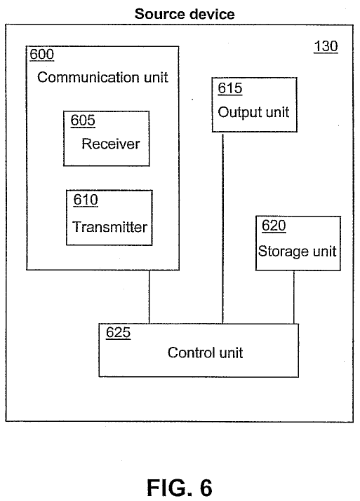

FIG. 6 is a block diagram of source device 130 in accordance with an embodiment of the present invention. FIG. 6 shows the source device having various components, but it is understood that implementing all of the illustrated components is not a requirement. Greater or fewer components may alternatively be implemented.

FIG. 6 shows communication unit 600 configured with several commonly implemented components. For instance, the communication unit typically includes one or more components which permit wired or wireless communication between the source device and other components or devices, such as access point 140 or other network components or related devices. The embodiment of FIG. 6 depicts the communication unit with receiver 605 and transmitter 610.

Output unit 615 generally includes components which support the output requirements (e.g., audio and display) of the source device. Examples of such components includes a speaker or other audio producing device for generating audio, and a display for display images, graphics, and other data.

It is possible that the source device does not include capabilities for storing all of the service applications components for delivering to the presentation device. This type of source device would typically be unable to directly provide the components to the presentation device. Two alternatives for such devices are as follows. One option includes returning a pointer to a remote location where the presentation device can fetch the components itself. A second option is useful when the presentation device doesn't have the necessary resources (network access, protocol, and the like) to fetch the components itself. In this second option, the source device requests dynamically the components from the backend of its service, and forwards it to the requesting presentation device.

Storage unit 620 is generally used to store various types of data to support the processing, control, and storage requirements of the source device. Examples of such data include program instructions for applications operating on the source device, images, graphics, pictures, video, and the like. The storage unit may be implemented using any type (or combination) of suitable volatile and non-volatile memory or storage devices including random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, card-type memory, or other similar memory or data storage device.

Control emit 625 typically controls the overall operations of the source device. For instance, the controller performs the control and processing associated with data communications, storing operations, and other general or specific functions provided by the source device. If desired, presentation device 145 may be configured in a manner similar to source device 130, such that the presentation device may be configured using some or all of the components depicted in FIG. 6.

Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In some cases, such embodiments are implemented by control unit 625.

For a software implementation, the embodiments described herein may be implemented with separate software modules, such as procedures and functions, each of which perform one or more of the functions and operations described herein. The software codes can be implemented with a software application written in any suitable programming language and may be stored in memory (for example, storage unit 620), and executed by a controller or processor (for example, control unit 625).

While the invention herein disclosed has been described by means of specific embodiments, examples and applications thereof, numerous modifications and variations could be made thereto by those skilled in the art without departing from the scope of the invention set forth in the claims.

What is claimed is:

1. A method to facilitate interaction between services provided by respective networked devices, the method comprising:
receiving service capabilities associated with a source device which has joined a first network;
receiving a service application at a presentation device, the service application being associated with at least one service identified by the service capabilities associated with the source device; and
presenting a service associated with the source device on the presentation device utilizing the service application.

2. The method according to claim 1, wherein the service application is configured to permit the presentation device to present the service, to provide a user interface for the service, and to provide control of the service.

3. The method according to claim 1, wherein the service application is configured to permit the presentation device to present the service based upon the service application, and wherein the presenting of the service further comprises:
presenting a user interface for the service and permitting control of the service based upon an application residing at the presentation device.

4. The method according to claim 1, further comprising:
providing a user-selectable option for the presenting of the service, wherein a first option comprises:
the service application being configured to permit the presentation device to present the service, to provide a user interface for the service, and to provide control of the service, and wherein a second option comprises:
the service application being configured to permit the presentation device to present the service based upon the service application, and wherein the presenting of the service further comprises presenting the user interface for the service and permitting control for the service based upon an application residing at the presentation device.

5. The method according to claim 1, further comprising:
receiving a plurality of service applications at the presentation device, each of the service applications being associated with at least one service identified by the service capabilities associated with the source device; and
presenting simultaneously a plurality of services associated with the source device on the presentation device utilizing the plurality of service applications.

6. The method according to claim 1, further comprising:
receiving service capabilities associated with a plurality of source devices which each has joined the first network;
receiving a service application from each of the plurality of source devices at the presentation device, wherein each of the service applications is associated with at least one service identified by the service capabilities associated with one of the plurality of source devices; and
presenting simultaneously a plurality of services individually associated with one of the plurality of source devices on the presentation device utilizing the service application from each of the plurality of source devices.

7. The method according to claim 1, further comprising:
interacting with a remote service via a second network, wherein the service associated with the source device comprises data provided by the remote service.

8. The method according to claim 1, further comprising:
automatically receiving the service application at the presentation device.

9. The method according to claim 1, further comprising:
permitting user interaction with the service via the presentation device.

10. The method according to claim 1, wherein the presenting the service further comprises:
presenting options which differ from options possible using the source device.

11. The method according to claim 1, wherein the service comprises a user interface which is essentially the same as a user interface for the service presented on the source device.

12. The method according to claim 1, wherein the first network comprises a wireless peer-to-peer network.

13. The method according to claim 1, wherein the services comprises an interactive user application.

14. The method according to claim 1, wherein the presentation device comprises a digital interactive television.

15. An apparatus comprising:
a receiver configured to:
receive service capabilities associated with a source device which has joined a first network; and
receive a service application, the service application being associated with at least one service identified by the service capabilities associated with the source device; and
a display configured to:
present a service associated with the source device utilizing the service application.

16. The apparatus according to claim 15, wherein the service application is configured:
to permit the apparatus to present the service,
to provide a user interface for the service, and
to provide control of the service.

17. The apparatus according to claim 15, wherein the service application is configured:
to permit the apparatus to present the service based upon the service application, and wherein the display is further configured, based upon an application residing at the apparatus, to:
present a user interface for the service, and
permit control of the service.

18. The apparatus according to claim 15, wherein the display is further configured to:
provide a user-selectable option for the presenting of the service, wherein a first option comprises:
the service application being configured to permit the apparatus:
to present the service,
to provide a user interface for the service, and
to provide control of the service, and wherein a second option comprises the service application being configured to permit the apparatus:
to provide the service based upon the service application, and wherein the service comprises presenting the user interface for the service and permitting control for the service based upon an application residing at the apparatus.

19. The apparatus according to claim 15, wherein the receiver is further configured to:
receive a plurality of service applications, each of the service applications being associated with at least one service identified by the service capabilities associated with the source device, and wherein the display is further configured to:
present a plurality of services associated with the source device utilizing the plurality of service applications.

20. The apparatus according to claim 15, wherein the receiver is further configured to:
receive service capabilities associated with a plurality of source devices which each has joined the first network;
receive a service application from each of the plurality of source devices at the presentation device, wherein each of the service applications is associated with at least one service identified by the service capabilities associated with one of the plurality of source devices; and wherein the display is further configured to:
present a plurality of services individually associated with one of the plurality of source devices utilizing the service application from each of the plurality of source devices.

21. A method to facilitate interaction between networked devices, the method comprising:
detecting presence of a source device of a first network;
obtaining service capabilities associated with the source device;
obtaining a service application from the source device, the service application being associated with at least one service identified by the service capabilities associated with the source device; and
providing the service application to a presentation device operable within the first network, the service application being configured to permit the presentation device to present a service associated with the source device utilizing the service application.

22. The method according to claim 21, wherein the service application is configured to permit the presentation device to present the service, to provide a user interface for the service, and to provide control of the service.

23. The method according to claim 21, further comprising:
providing a plurality of service applications to the presentation device, each of the service applications being associated with at least one service identified by the service capabilities associated with the source device, and wherein each of the plurality of service applications is configured to permit the presentation device to present one of a plurality of services associated with the source device.

24. The method according to claim 21, further comprising:
detecting presence of a plurality of source devices of the first network;
obtaining service capabilities associated with each of the plurality of source devices;
obtaining a service application from each of the plurality of source devices, wherein each of the service applications is associated with at least one service identified by the service capabilities associated with one of the plurality of source devices; and
providing the service applications to the presentation device, wherein each of the service applications is configured to permit the presentation device to present a service associated with the source device utilizing the service application.

25. The method according to claim 21, further comprising:
interacting with a remote service via a second network, wherein the service associated with the source device comprises data provided by the remote service.

26. The method according to claim 21, wherein the first network comprises a wireless peer-to-peer network.

27. An apparatus comprising:
a receiver configured to:
detect presence of a source device;
obtain service capabilities associated with the source device;
obtain a service application from the source device, the service application being associated with at least one service identified by the service capabilities associated with the source device; and
a transmitter configured to:
provide the service application to a presentation device operable within a first network, the service application being configured to permit the presentation device to present a service associated with the source device utilizing the service application.

28. The apparatus according to claim 27, wherein the service application is configured:
to permit the presentation device to present the service,
to provide a user interface for the service, and
to provide control of the service.

29. The apparatus according to claim 27, wherein the transmitter is further configured to:
provide a plurality of service applications to the presentation device, each of the service applications being associated with at least one service identified by the service capabilities associated with the source device, and wherein each of the plurality of service applications is configured to permit the presentation device to present one of a plurality of services associated with the source device.

30. The apparatus according to claim 27, wherein the transmitter is further configured to:
detect presence of a plurality of source devices;
obtain service capabilities associated with each of the plurality of source devices;
obtain a service application from each of the plurality of source devices, wherein each of the service applications is associated with at least one service identified by the service capabilities associated with one of the plurality of source devices; and wherein the transmitter is further configured to:
provide the service applications to the presentation device, wherein each of the service applications is configured to permit the presentation device to present a service associated with the source device utilizing the service application.
